(19) United States
(12) Patent Application Publication
(10) Pub. No.: US 2023/0186679 A1
(43) Pub. Date: Jun. 15, 2023

(54) ELECTRONIC APPARATUS AND CONTROL METHOD

(71) Applicant: Lenovo (Singapore) Pte. Ltd., Singapore (SG)

(72) Inventor: Kazuhiro Kosugi, Kanagawa (JP)

(73) Assignee: Lenovo (Singapore) Pte. Ltd., Singapore (SG)

(21) Appl. No.: 18/052,937

(22) Filed: Nov. 7, 2022

(30) Foreign Application Priority Data
Dec. 10, 2021 (JP) 2021-201091

(51) Int. Cl. G06V 40/16; G06T 7/70; G06T 7/62

(52) U.S. Cl. CPC G06V 40/161; G06T 7/62; G06T 7/70

(57) ABSTRACT

An electronic apparatus includes: a memory which temporarily stores image data of an image captured by an imaging device; and a processor which processes image data stored in the memory. The processor has a first detection mode in which a face area is detected with a first detection accuracy from the image of image data stored in the memory, and a second detection mode in which the face area is detected with a second detection accuracy higher than the first detection accuracy. When the face area is detected in the second detection mode, the processor executes face detection processing in which a first area based on the face area detected in the second detection mode is set, and upon detecting the face area in the first detection mode, the face area is detected with different detection conditions between the first area and a second area other than the first area.

### CROSS-REFERENCE TO RELATED APPLICATIONS

This application claims priority to Japanese Patent Application No. 2021-201091 filed on Dec. 10, 2021, the contents of which are hereby incorporated herein by reference in their entirety.

### TECHNICAL FIELD

The present invention relates to an electronic apparatus and a control method.

### BACKGROUND

There is an electronic apparatus which makes a transition to a usable operating state when a person approaches or to a standby state in which functions except some of the functions are stopped when the person leaves. For example, in Japanese Unexamined Patent Application Publication No. 2016-148895, a technique for controlling the operating state of an electronic apparatus by using an infrared sensor to detect the intensity of infrared light in order to detect whether a person is approaching or a person has left is disclosed.

In recent years, with the development of computer vision and the like, technology to detect a face from an image has become common, and the operating state of an electronic apparatus has also been controlled depending on whether or not a face is detected from an image captured in front of the electronic apparatus. When using the infrared sensor, infrared light is reflected on and returned from a target regardless of whether the target is a person or any object other than the person, but the use of face detection can prevent just an object from being detected as a person by mistake.

However, even when using face detection, a face may not be able to be detected correctly due to various factors such as wearing a face mask and a face orientation, and the face detection may become unstable. Unstable face detection affects the state control of the electronic apparatus. For example, the transition to the usable state may not be made even when a person is approaching, or the transition to the standby state may not be made even when the person goes away. In such a case, although a method of making the detection accuracy of face detection as high as possible by using the infrared sensor together or increasing the frame rate during face detection can be considered, there is a problem of increasing power consumption to increase the detection accuracy. It is desirable to reduce power consumption as much as possible in order to constantly detect the approach or leave of a person.

### SUMMARY

One or more embodiments of the present invention provide an electronic apparatus and a control method for performing stable face detection while reducing the detection accuracy.

An electronic apparatus according to one or more embodiments of the present invention includes: a memory which temporarily stores image data of an image captured by an imaging device; and a processor which processes image data stored in the memory, wherein the processor has a first detection mode in which a face area with a face captured therein is detected with a first detection accuracy from the image of image data stored in the memory, and a second detection mode in which the face area is detected with a second detection accuracy higher than the first detection accuracy, and when the face area is detected in the second detection mode, the processor executes face detection processing in which a first area based on the face area detected in the second detection mode is set, and upon detecting the face area in the first detection mode, the face area is detected with different detection conditions between the first area and a second area other than the first area.

The above electronic apparatus may be such that, in the face detection processing, the processor detects an area, in which a face-likeness evaluation value is a first threshold value or more, as the face area from the image, and the first threshold value in the first area is set lower than the first threshold value in the second area.

The above electronic apparatus may also be such that, in the face detection processing, the processor changes the position or size of the first area according to a change in the position or size of the face area detected in the first detection mode.

The above electronic apparatus may further be such that the imaging device includes a first image sensor for imaging visible light and a second image sensor for imaging infrared light, and the first detection mode is a detection mode in which imaging is done using only the first image sensor of the first image sensor and the second image sensor, and the second detection mode is a detection mode in which imaging is done using at least the second image sensor.

Further, the above electronic apparatus may be such that the first detection mode is a detection mode in which power consumed in the face detection processing is lower than that in the second detection mode.

Further, the above electronic apparatus may be such that the first detection mode is a detection mode for detecting the face area from the image, and the second detection mode is a detection mode for detecting the face area to perform face authentication from the image.

Further, the above electronic apparatus may be such that, when the face area cannot be detected in the first area in the first detection mode, the processor cancels the first area.

Further, the above electronic apparatus may be such that, when the face area cannot be detected in the first area in the first detection mode, the processor cancels the first area, and after canceling the first area, when the face area in which the evaluation value becomes a second threshold value or more is detected in the first detection mode, where the second threshold value is higher than the first threshold value, the processor sets the first area based on the detected face area again.

An electronic apparatus according to one or more embodiments of the present invention includes: a memory which temporarily stores image data of an image captured by an imaging device; and a processor which processes image data stored in the memory, wherein the processor executes face detection processing to detect an area, in which a face-likeness evaluation value is a first threshold value or more, as a face area from the image of image data stored in the memory, and in the face detection processing, when the face area in which the evaluation value becomes a second threshold value or more is detected, where the second threshold value is higher than the first threshold value, the processor sets a first area based on the detected face area to detect the face area with different detection conditions between the first area and a second area other than the first area upon detecting the face area after that.

Further, a control method according to one or more embodiments of the present invention is a control method for an electronic apparatus including a memory which temporarily stores image data of an image captured by an imaging device, and a processor which processes image data stored in the memory, wherein the processor has a first detection mode in which a face area with a face captured therein is detected with a first detection accuracy from the image of image data stored in the memory, and a second detection mode in which the face area is detected with a second detection accuracy higher than the first detection accuracy, the control method including: a step in which, when the face area is detected in the second detection mode, a first area based on the face area detected in the second detection mode is set; and a step in which, upon detecting the face area in the first detection mode, the face area is detected with different detection conditions between the first area and a second area other than the first area.

Further, a control method according to one or more embodiments of the present invention is a control method for an electronic apparatus including a memory which temporarily stores image data of an image captured by an imaging device, and a processor which processes image data stored in the memory, the control method including: a step of causing the processor to detect an area, in which a face-likeness evaluation value is a first threshold value or more, as a face area from the image of image data stored in the memory; a step in which, when the face area in which the evaluation value becomes a second threshold value or more is detected, where the second threshold value is higher than the first threshold value, the processor sets a first area based on the detected face area; and a step in which, upon detecting the face area after that, the processor detects the face area with different detection conditions between the first area and a second area other than the first area.

The above-described aspects of the present invention can perform stable face detection while reducing the detection accuracy.

### BRIEF DESCRIPTION OF THE DRAWINGS

FIGS. 1(A) to 1(C) are diagrams for describing an outline of HPD processing of an electronic apparatus according to one or more embodiments.

FIG. 2 is a diagram illustrating an example of a captured image with a face area detected therein.

FIG. 3 is a diagram illustrating an example of a captured image with no face area detected therein.

FIG. 4 is a diagram illustrating an example of setting a high reliability area according to one or more embodiments.

FIG. 5 is a table illustrating an example of comparisons between a standard detection mode and a high-accuracy detection mode according to one or more embodiments.

FIG. 6 is a perspective view illustrating an appearance configuration example of the electronic apparatus according to one or more embodiments.

FIG. 7 is a block diagram illustrating an example of the hardware configuration of the electronic apparatus according to one or more embodiments.

FIG. 8 is a block diagram illustrating an example of the configuration of a face detection unit according to one or more embodiments.

FIGS. 9(A) and 9(B) are explanatory diagrams of tracking of the high reliability area according to one or more embodiments.

FIG. 10 is a flowchart illustrating an example of face detection processing in the standard detection mode according to one or more embodiments.

FIG. 11 is a flowchart illustrating an example of face detection processing in the standard detection mode according to one or more embodiments.

### DETAILED DESCRIPTION

Embodiments of the present invention will be described below with reference to the accompanying drawings.

### First Embodiment>

First, the outline of an electronic apparatus 1 according to one or more embodiments will be described.

The electronic apparatus 1 according to one or more embodiments is, for example, a laptop PC (Personal Computer).

The electronic apparatus 1 has at least a “normal operating state” and a “standby state” as system operating states. The normal operating state is an operating state capable of executing processing without being particularly limited, which corresponds, for example, to S0 state defined in the ACPI (Advanced Configuration and Power Interface) specification.

The standby state is a state in which the use of at least some functions of the system are limited. For example, the standby state may be the standby state or a sleep state, which is a state corresponding to modern standby in Windows (registered trademark), S3 state (sleep state) defined in the ACPI specification, or the like. Note that the standby state may also be a state in which at least the display of a display unit appears to be OFF (screen OFF), or a screen lock state. The screen lock is a state in which an image preset to make a processed content invisible (for example, an image for the screen lock) is displayed on the display unit, that is, an unusable state until the lock is released by user authentication or the like. In other words, the standby state corresponds, for example, to any one of an operating state lower in power consumption than the normal operating state, a state in which a working content of the electronic apparatus 1 is not visible to a user, and a state in which the user cannot use the electronic apparatus 1.

Further, the system operating states include “stopped states” further lower in power consumption than the standby state. For example, the stopped states are a hibernation state, a power-off state, and the like. The hibernation state corresponds, for example, to S4 state defined in the ACPI specification. The power-off state corresponds, for example, to S5 state (shutdown state) defined in the ACPI specification.

In the following, a transition of the system operating state from the standby state or the stopped state to the normal operating state may also be called “boot.” For example, since the standby state and the stopped state are lower in activation level than the normal operating state, the boot of the system of the electronic apparatus 1 leads to the activation of the operation of the system in the electronic apparatus 1.

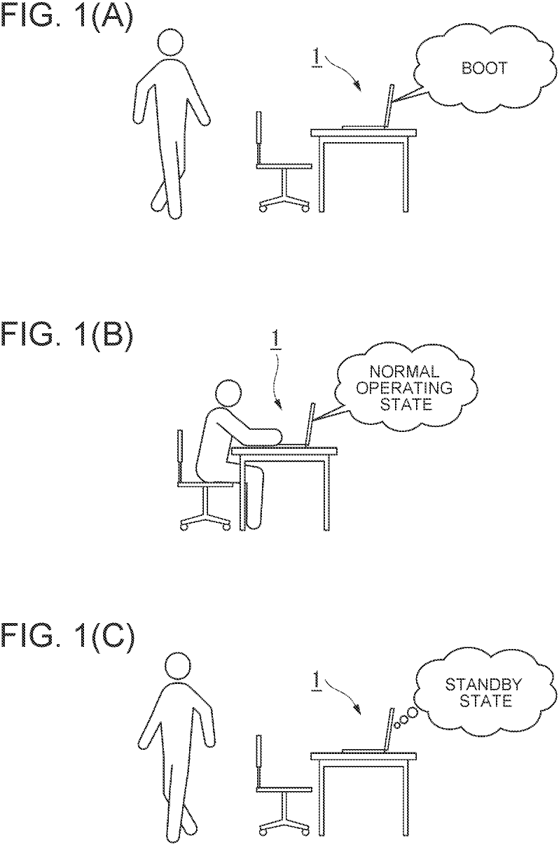

FIGS. 1(A) to 1(C) are diagrams for describing an outline of HPD processing of the electronic apparatus 1 according to one or more embodiments. The electronic apparatus 1 detects a person (i.e., the user) present in the neighborhood of the electronic apparatus 1. This processing to detect the presence of a person is called HPD (Human Presence Detection) processing. The electronic apparatus 1 detects the presence or absence of a person by the HPD processing to control the operating state of the system of the electronic apparatus 1 based on the detection result. For example, as illustrated in FIG. 1(A), when detecting a change from a state where no person is present in front of the electronic apparatus 1 (Absence) to a state where a person is present (Presence), that is, when detecting that a person has approached the electronic apparatus 1 (Approach), the electronic apparatus 1 determines that the user has approached and automatically boots the system to make the transition to the normal operating state. Further, in a state where a person is present in front of the electronic apparatus 1 (Presence) as illustrated in FIG. 1(B), the electronic apparatus 1 determines that the user is present and continues the normal operating state. Then, as illustrated in FIG. 1(C), when detecting a change from the state where the person is present in front of the electronic apparatus 1 (Presence) to a state where no person is present (Absence), that is, when detecting that the person has left the electronic apparatus 1 (Leave), the electronic apparatus 1 determines that the user has left and causes the system to make the transition to the standby state.

For example, the electronic apparatus 1 has a face detection function to detect a face area with a face captured therein from a captured image captured forward (on the front side) in order to determine whether or not the user is present in front of the electronic apparatus 1. When the face area is detected from the captured image, the electronic apparatus 1 determines that the user is present. On the other hand, when no face area is detected from the captured image, the electronic apparatus 1 determines that the user is not present. In other words, when the face area is detected from a state in which no face area is detected from the captured image, the electronic apparatus 1 detects that the user has approached the electronic apparatus 1 (Approach), and causes the system to make the transition to the normal operating state. Further, when any face area is no longer detected from the state in which the face area is detected from the captured image, the electronic apparatus 1 detects that the user has left the electronic apparatus 1 (Leave), and causes the system to make the transition to the standby state.

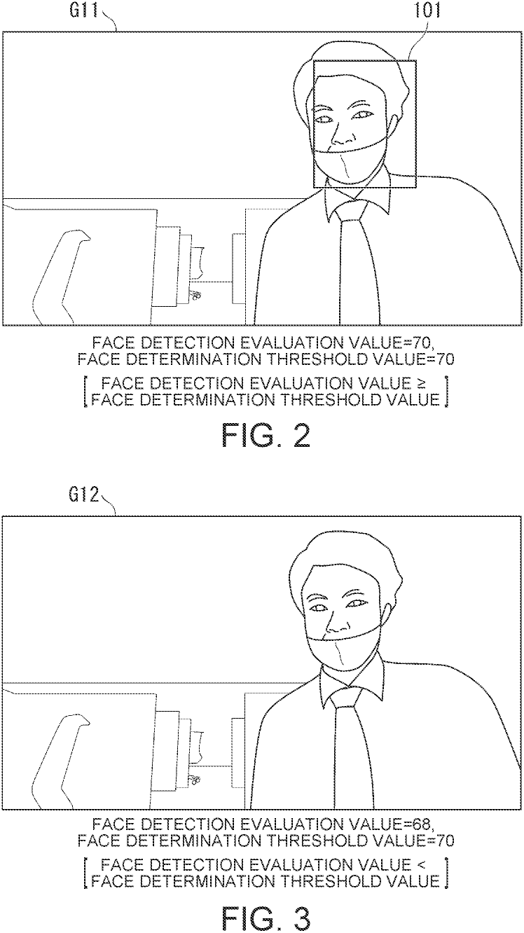

Here, when detecting the face area from the captured image, the face area may not be able to be detected correctly due to factors such as wearing a face mask and the like, and face detection may become unstable. FIG. 2 and FIG. 3 illustrate examples of captured images for face detection. FIG. 2 is a diagram illustrating an example of a captured image with a face area detected therein. On the other hand, FIG. 3 is a diagram illustrating an example of a captured image with no face area detected therein.

In FIG. 2, a bounding box 101 indicates a face area detected from a captured image G11. As the detection method of the face area, any detection method using a face detection algorithm to detect a face based on facial feature information, using trained data (learned model) subjected to machine learning based on the facial feature information or a face image, using a face detection library, or the like can be applied. For example, the electronic apparatus 1 uses the trained data subjected to machine learning by reading image data of plural face images to acquire an evaluation value (hereinafter called a “face detection evaluation value”) indicative of a face likeness from among the captured images, and detect, as a face area, an area in which the face detection evaluation value becomes a predetermined threshold value (hereinafter called a “face determination threshold value”) or more. As an example, when the face determination threshold value is “70,” since the face detection evaluation value is “70” in the example illustrated in FIG. 2 and the face detection evaluation value is equal to or more than the face determination threshold value, the area is detected as the face area. On the other hand, in the example illustrated in FIG. 3, since the face detection evaluation value is “68” and the face detection evaluation value is less than the face determination threshold value, no area is detected as the face area. The bounding box 101 is to visualize coordinate information on the position and size (length and width) of the detected face area (coordinate information in the image area). For example, the face area detection result is output as information including the face area coordinate information and the face detection evaluation value.

Thus, when the face detection evaluation value gets close to a border by the face determination threshold value due to a factor of wearing a face mask or the like, face detection may become unstable to be or not to be determined as a face. Note that the factor is not limited to the case of wearing a face mask, and the face detection evaluation value may also get close to the border by the face determination threshold value due to various factors including a face orientation. For example, when the face determination threshold value is lowered, an area not to be detected as the face area as illustrated in FIG. 3 is more likely to be detected as the face area, but on the other hand, any other area without a person’s face is more likely to be erroneously detected as the face area depending on the wrinkles of clothes, the arrangement situation of objects, or the like.

Therefore, in one or more embodiments, when a face area is detected in a detection mode for detecting the face area with a detection accuracy higher than that of face detection in the HPD processing, since the detection result can be determined to be highly reliable (the possibility that there is a face is high), only the face determination threshold value in a specific area based on the detected face area is lowered. Thus, since a person’s face area is more likely to be detected as the face area correctly without increasing the chances that other areas with no person’s face are erroneously detected as the face area, stable face detection can be realized.

In the following, a face detection mode in the HPD processing is called a “standard detection mode,” and a detection mode for detecting the face area with a detection accuracy higher than that of the face detection in the HPD processing is called a “high-accuracy detection mode.” Further, a specific area based on the detected face area in the high-accuracy detection mode (an area in which the reliability of the face area detection result is high) is called a “high reliability area,” and any other area of the captured image is called a “standard area.”

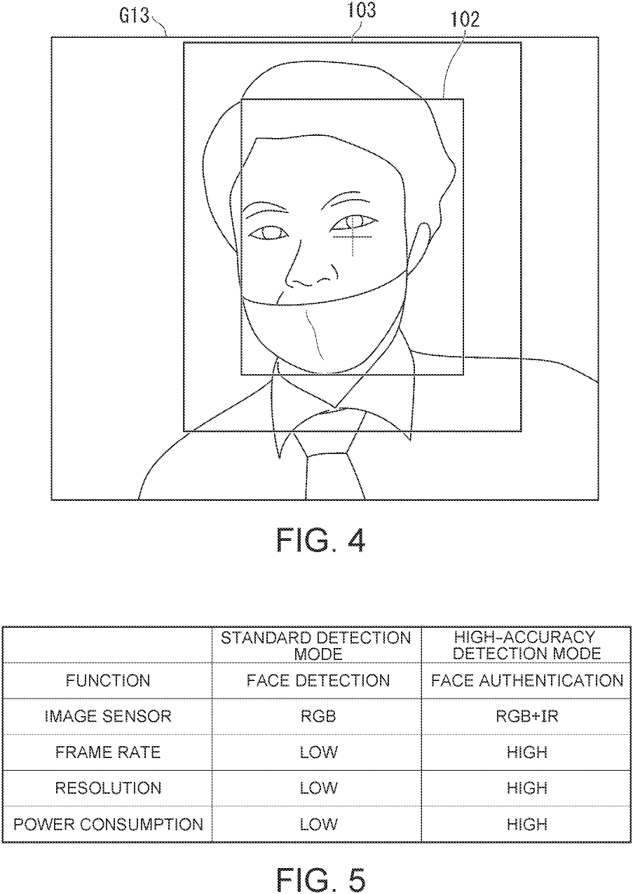

FIG. 4 is a diagram illustrating an example of setting a high reliability area according to one or more embodiments. A bounding box 102 indicates a face area detected from a captured image G13 in the high-accuracy detection mode. A high reliability area 103 is set as an area including this bounding box 102 and wider than the bounding box 102. For example, the high reliability area 103 is set as an area whose center is the center of the bounding box 102 and whose vertical and horizontal lengths are wider than the vertical and horizontal lengths of the bounding box 102 by adding a predetermined percentage (for example, 50%). When a face area is detected from a captured image in the standard detection mode in the HPD processing, only the face determination threshold value in the high reliability area 103 is set to be lowered. For example, the face determination threshold value in the high reliability area 103 is set to a value lower by a predetermined percentage (for example, 10%) than the face determination threshold value for the standard area other than the high reliability area 103.

For example, when the face determination threshold value of the standard areas is “70,” the face determination threshold value of the high reliability area is set to “63.” In the examples illustrated in FIG. 2 and FIG. 3, when no high reliability area is set, the face area is detected (FIG. 2: face detection evaluation value = 70), or no face area is detected (FIG. 3: face detection evaluation value =68). On the other hand, when the high reliability area is so set that the face determination threshold value becomes “63,” both the face detection evaluation values in FIG. 2 and FIG. 3 become the face determination threshold value or more, and hence the face area is detected stably.

Note that the face determination threshold value in the standard area is not set to one value, which is a value that changes according to the brightness of the captured image and the like. The face determination threshold value in the high reliability area 103 is set to a value lower by a predetermined percentage (for example, 10%) than the face determination threshold value in the standard area at each time.

Further, the number of face areas detected from the captured image is not limited to one. However, even when two or more face areas are detected, the high reliability area is set to the most main face area among the face areas detected from the captured image. The most main face area is, for example, the largest face area among the face areas detected from the captured image. Further, the most main face area may be determined based on the positional factor in the captured image (for example, the position near the center) instead of or in addition to the size of the face area.

Referring next to FIG. 5, differences between the standard detection mode and the high-accuracy detection mode will be described. FIG. 5 is a table illustrating an example of comparisons between the standard detection mode and the high-accuracy detection mode according to one or more embodiments. The standard detection mode is used for the face detection function. On the other hand, the high-accuracy detection mode is used for face authentication. In face authentication processing, the high-accuracy detection mode is required because there is a need to check on the facial features with a higher accuracy. For example, when a face authentication function is used in authentication processing at login, authentication processing when accessing data to which access is limited, or the like, the high-accuracy detection mode is applied.

Further, in the standard detection mode, an image is captured by using an RGB sensor imaging visible light as the image sensor. On the other hand, in the high-accuracy detection mode, an image is captured by using an IR (Infrared Radiation) sensor capable of imaging infrared light in addition to the RGB sensor. Note that in the high-accuracy detection mode, the image may also be captured by using only the IR sensor of the RGB sensor and the IR sensor. By using the IR sensor, facial features required for face authentication can be captured even in a low light environment, but power consumption becomes high because of emitting infrared light. Further, in the high-accuracy detection mode, the frame rate is set higher than that in the standard detection mode to detect a face area, thus increasing the detection accuracy. In this case, power consumption also increases by the increase in frame rate. Note that in the high-accuracy detection mode, the face area may also be detected in a resolution higher than that in the standard detection mode.

In other words, it can be said that the standard detection mode is a detection mode for capturing an image by using only the RGB sensor of the RGB sensor and the IR sensor, and the high-accuracy detection mode is a detection mode for capturing an image using at least the IR sensor. Further, it can be said that the standard detection mode is a detection mode in which power consumed in the face detection processing is lower than that in the high-accuracy detection mode. Further, it can be said that the standard detection mode is a detection mode for detecting a face area from a captured image, and the high-accuracy detection mode is a detection mode for detecting the face area from the captured image to perform face authentication.

Although the differences between the standard detection mode and the high-accuracy detection mode are described with reference to FIG. 5, the function, the image sensor, the frame rate, and the resolution in the high-accuracy detection mode do not need to be all different from those in the standard detection mode as long as the face area can be detected with an accuracy higher than that in the standard detection mode. For example, the image sensors are different between the standard detection mode and the high-accuracy detection mode, but either or both of the frame rate and the resolution may be the same. Further, the image sensor may be the same as long as either or both of the frame rate and the resolution are different between the standard detection mode and the high-accuracy detection mode. In any case, since power consumption in the high-accuracy detection mode becomes higher than that in the standard detection mode, a high reliability area is set in the standard detection mode by using the detection result in the high-accuracy detection mode to detect a face area, and hence stable face detection can be realized without increasing power consumption.

Next, the configuration of the electronic apparatus 1 according to one or more embodiments will be described in detail.

### Appearance Configuration of Electronic Apparatus

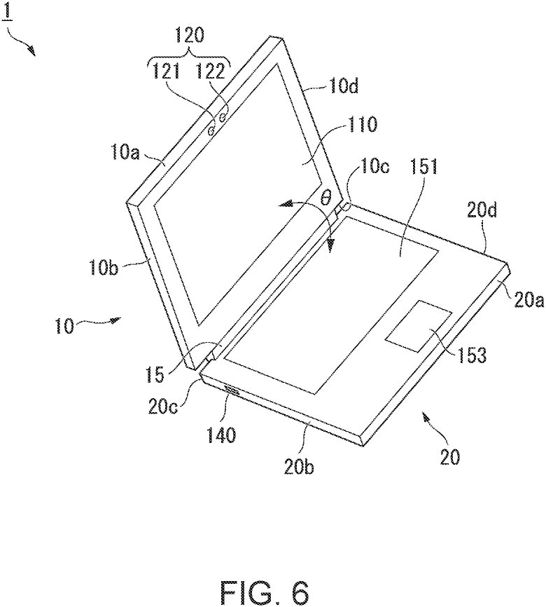

FIG. 6 is a perspective view illustrating an appearance configuration example of the electronic apparatus 1 according to one or more embodiments.

The electronic apparatus 1 includes a first chassis 10, a second chassis 20, and a hinge mechanism 15. The first chassis 10 and the second chassis 20 are coupled by using the hinge mechanism 15. The first chassis 10 is rotatable around an axis of rotation formed by the hinge mechanism 15 relative to the second chassis 20. An open angle by the rotation between the first chassis 10 and the second chassis 20 is denoted by “θ” in FIG. 6.

The first chassis 10 is also called A cover or a display chassis. The second chassis 20 is also called C cover or a system chassis. In the following description, side faces on which the hinge mechanism 15 is provided among side faces of the first chassis 10 and the second chassis 20 are referred to as side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c to the side face 20a is referred to as “front.” The right hand and left hand in the rearward direction are referred to as “right” and “left,” respectively. Left side faces of the first chassis 10 and the second chassis 20 are referred to as side faces 10b and 20b, respectively, and right side faces thereof are referred to as side faces 10d and 20d, respectively. Further, a state where the first chassis 10 and the second chassis 20 overlap each other and are completely closed (a state of open angle 6 = 0°) is referred to as a “closed state.” The faces of the first chassis 10 and the second chassis 20 on the face-to-face sides in the closed state are referred to as respective “inner faces,” and the faces opposite to the inner faces are referred to as “outer faces.” Further, a state opposite to the closed state, where the first chassis 10 and the second chassis 20 are open, is referred to as an “open state.”

The appearance of the electronic apparatus 1 in FIG. 6 illustrates an example of the open state. The open state is a state where the side face 10a of the first chassis 10 and the side face 20a of the second chassis 20 are separated. In the open state, the respective inner faces of the first chassis 10 and the second chassis 20 appear. The open state is one of states when the user uses the electronic apparatus 1, and the electronic apparatus 1 is often used in a state where the open angle is typically about θ = 100° to 130°. Note that the range of open angles θ to be the open state can be set arbitrarily according to the range of angles rotatable by the hinge mechanism 15 or the like.

A display unit 110 is provided on the inner face of the first chassis 10. The display unit 110 is configured to include a liquid crystal display (LCD) or an organic EL (Electro Luminescence) display, and the like. Further, an imaging unit 120 is provided in a peripheral area of the display unit 110 on the inner face of the first chassis 10. For example, the imaging unit 120 is arranged on the side of the side face 10a in the peripheral area of the display unit 110. Note that the position at which the imaging unit 120 is arranged is just an example, and it may be elsewhere as long as the imaging unit 120 can face a direction (frontward) to face the inner face of the first chassis 10.

In the open state, the imaging unit 120 captures an image in a predetermined imaging range in the direction (frontward) to face the inner face of the first chassis 10. The predetermined imaging range is a range of angles of view defined by an image sensor included in the imaging unit 120 and a lens provided in front of the imaging surface of the image sensor. For example, the imaging unit 120 has two cameras of a first camera 121 and a second camera 122.

The first camera 121 is a camera having, as an image sensor, the RGB sensor for receiving visible light incident through a lens to photoelectrically convert the visible light. Further, the second camera 122 is a camera having, as an image sensor, the IR sensor for receiving infrared light incident through a lens to photoelectrically convert the infrared light. The first camera 121 and the second camera 122 can capture images including a person present in front of the electronic apparatus 1, respectively.

Further, a power button 140 is provided on the side face 20b of the second chassis 20. The power button 140 is an operating element used by the user to give an instruction to power on (transition from the stopped state to the normal operating state) or power off (transition from the normal operating state to the stopped state). Further, a keyboard 151 and a touch pad 153 are provided as an input device on the inner face of the second chassis 20. Note that a touch sensor may also be included as the input device instead of or in addition to the keyboard 151 and the touch pad 153, or a mouse and an external keyboard may also be connected. When the touch sensor is provided, an area corresponding to the display surface of the display unit 110 may be constructed as a touch panel. Further, a microphone used to input voice may be included in the input device.

In the closed state where the first chassis 10 and the second chassis 20 are closed, the display unit 110 and the imaging unit 120 provided on the inner face of the first chassis 10, and the keyboard 151 and the touch pad 153 provided on the inner face of the second chassis 20 are covered with each other’s chassis faces, respectively. In other words, in the closed state, the electronic apparatus 1 is put in a state of being disabled from fulfilling at least input/output functions.

### Hardware Configuration of Electronic Apparatus

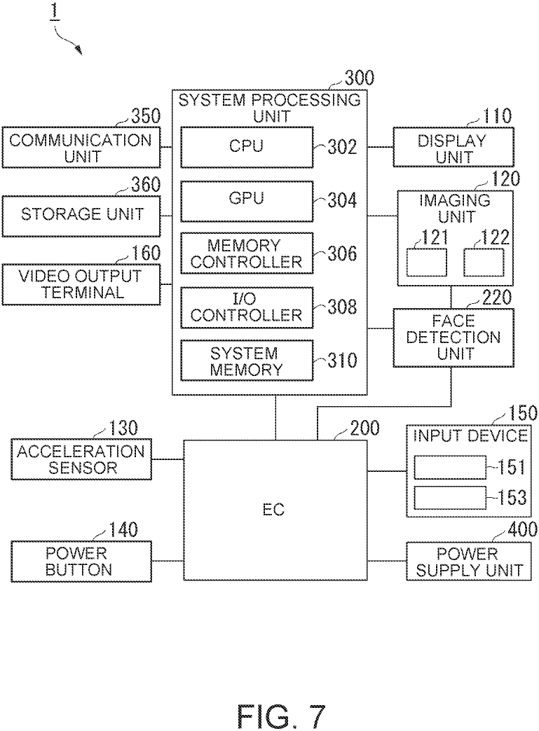

FIG. 7 is a block diagram illustrating an example of the hardware configuration of the electronic apparatus 1 according to one or more embodiments. In FIG. 7, components corresponding to those in FIG. 6 are given the same reference numerals. The electronic apparatus 1 is configured to include the display unit 110, the imaging unit 120, an acceleration sensor 130, the power button 140, an input device 150, a video output terminal 160, an EC (Embedded Controller) 200, a face detection unit 220, a system processing unit 300, a communication unit 350, a storage unit 360, and a power supply unit 400. The display unit 110 displays display data (images) generated based on system processing executed by the system processing unit 300, processing of an application program running on the system processing, and the like.

The imaging unit 120 has the first camera 121 and the second camera 122, each of which captures an image of an object within a predetermined angle of view in a direction (frontward) to face the inner face of the first chassis 10, and outputs image data of the captured image to the system processing unit 300 and the face detection unit 220, respectively. As described with reference to FIG. 6, the first camera 121 has the RGB sensor for receiving visible light to capture an image. The first camera 121 outputs image data of the captured visible light image. Further, the second camera 122 has the IR sensor and a light-emitting part to emit infrared light, where the IR sensor receives reflected light of the infrared light emitted from the light-emitting part to capture an image. The second camera 122 outputs image data of the captured infrared image (IR image). For example, image data of captured images captured by the imaging unit 120 are stored temporarily in a system memory 310 and used for image processing and the like.

Note that the configuration example in which the electronic apparatus 1 includes two cameras of the first camera 121 having the RGB sensor and the second camera 122 having the IR sensor is described in one or more embodiments, but the present invention is not limited to this example. For example, the electronic apparatus 1 may also be configured to include one camera capable of outputting image data of a visible light image (RGB image) and image data of an infrared image (IR image) by using one image sensor (a so-called hybrid image sensor) in which both pixels for receiving visible light and pixels for receiving infrared light are arranged.

The acceleration sensor 130 detects the orientation of the electronic apparatus 1 with respect to the direction of gravity, and outputs a detection signal indicative of the detection result to the EC 200. For example, the acceleration sensor 130 is provided in each of the first chassis 10 and the second chassis 20 to detect each of the orientation of the first chassis 10 and the orientation of the second chassis 20, and output, to the EC 200, each of detection signals indicative of the detection results, respectively. Based on the detection results of the orientation of the first chassis 10 and the orientation of the second chassis 20, the open/closed state of the electronic apparatus 1, the open angle θ between the first chassis 10 and the second chassis 20, and the like can be detected. Note that a gyro sensor, a tilt sensor, a geomagnetic sensor, and the like may also be included instead of or in addition to the acceleration sensor 130.

The power button 140 outputs, to the EC 200, operation signals according to user’s operations. The input device 150 is an input unit for accepting user input, which is configured to include, for example, the keyboard 151 and the touch pad 153. In response to accepting operations on the keyboard 151 and the touch pad 153, the input device 150 outputs, to the EC 200, operation signals indicative of the operation content.

The video output terminal 160 is a connecting terminal for connecting to an external display (display device). For example, the video output terminal 160 is an HDMI (registered trademark) terminal, a USB Type-C terminal, a display port, or the like.

The power supply unit 400 supplies power through a power system for supplying power to each unit according to the operating state of each unit of the electronic apparatus 1. The power supply unit 400 includes a DC (Direct Current)/DC converter. The DC/DC converter converts the voltage of DC power, supplied from an AC (Alternate Current)/DC adapter or a battery pack, to a voltage required for each unit. The power with the voltage converted by the DC/DC converter is supplied to each unit through each power system. For example, the power supply unit 400 supplies power to each unit through each power system based on a control signal according to the operating state of each unit input from the EC 200.

The EC 200 is a microcomputer configured to include a CPU (Central Processing Unit), a RAM (Random Access Memory), a ROM (Read Only Memory), a flash ROM, multi-channel A/D input terminal and D/A output terminal, digital input/output terminals, and the like. For example, the CPU of the EC 200 reads a control program (firmware) prestored in the ROM or an external ROM and executes the read control program to fulfill the function. The EC 200 is connected to the acceleration sensor 130, the power button 140, the input device 150, the face detection unit 220, the system processing unit 300, the power supply unit 400, and the like.

For example, when receiving an operation signal according to a user’s operation to the power button 140, the EC 200 instructs the system processing unit 300 to boot the system or the like. Further, based on the detection result by the face detection unit 220, the EC 200 gives an instruction to boot the system or an instruction to make an operating state transition. Further, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the electronic apparatus 1.

Further, the EC 200 acquires operation signals from the input device 150 and the like, and outputs, to the system processing unit 300, an operation signal required in processing of the system processing unit 300 among the acquired operation signals. Further, the EC 200 acquires the detection signal from the acceleration sensor 130 to detect, based on the acquired detection signal, the orientation of the electronic apparatus 1 (the orientation of the first chassis 10 and the orientation of the second chassis 20), the open angle θ between the first chassis 10 and the second chassis 20, and the like.

Note that some of the functions of the EC 200 may also be configured as a sensor hub or a chipset.

The face detection unit 220 is a processor which processes image data of captured images captured by the imaging unit 120. The face detection unit 220 executes face detection processing and face authentication processing. For example, the face detection unit 220 executes the face detection processing for acquiring a captured image captured by the imaging unit 120 to detect a face area with a face captured therein from the acquired captured image.

Further, based on the detection result of the face detection processing, the face detection unit 220 executes HPD processing to detect whether or not a user (a person) is present in front of the electronic apparatus 1. Further, after detecting the face area from the captured image acquired from the imaging unit 120, the face detection unit 220 matches a face image in the detected face area with a preregistered face image (for example, a face image of an authorized user) to execute face authentication processing. The configuration of this face detection unit 220 will be described in detail later.

The system processing unit 300 is configured to include a CPU (Central Processing Unit) 302, a GPU (Graphic Processing Unit) 304, a memory controller 306, an I/O (Input-Output) controller 308, and the system memory 310, where processing of various application programs is executable on an OS (Operating System) by system processing based on the OS. The CPU 302 and the GPU 304 may be collectively called a processor.

The CPU 302 executes processing by the OS and processing by the application programs running on the OS. Further, the CPU 302 causes the operating state of the system to make a transition according to an instruction from the EC 200. For example, when the operating state is the stopped state or the standby state, and a boot instruction is received from the EC 200, the CPU 302 executes boot processing to make the transition from the stopped state or the standby state to the normal operating state. Further, when receiving an instruction to make the transition to the standby state in the normal operating state, the CPU 302 makes the transition from the normal operating state to the standby state. Further, when receiving a shutdown instruction in the normal operating state, the CPU 302 executes shutdown processing to make the transition from the normal operating state to the stopped state.

Further, the CPU 302 executes login processing to determine whether or not to allow access to the OS in the boot processing. When the boot processing by the OS is started, the CPU 302 executes the login processing before allowing the access to the OS, and the transition to the normal operating state is paused until login is allowed in the login processing. In the login processing, user authentication processing is performed to determine whether or not a person using the electronic apparatus 1 is a preregistered, authorized user. As the authentication, there are password authentication, face authentication, fingerprint authentication, and the like.

For example, when performing the user authentication processing by face authentication, the CPU 302 uses face authentication processing by the face detection unit 220. When the authentication result is successful, the CPU 302 allows the login and resumes the execution of the paused system processing. On the other hand, when the authentication result is unsuccessful, the CPU 302 does not allow the login and leaves the execution of the system processing paused.

The GPU 304 is connected to the display unit 110. The GPU 304 executes image processing under the control of the CPU 302 to generate display data. The GPU 304 outputs the generated display data to the display unit 110. Note that the CPU 302 and the GPU 304 may be integrally formed as one core, or the load may be shared between the CPU 302 and the GPU 304 formed as individual cores, respectively. The number of processors is not limited to one, and it may be plural.

The memory controller 306 controls reading data from and writing data to the system memory 310, the storage unit 360 and the like by the CPU 302 and the GPU 304.

The I/O controller 308 controls input/output of data from the communication unit 350, the display unit 110, and the EC 200.

The system memory 310 is used as a reading area of an execution program of the processor and a working area to write processed data. Further, the system memory 310 temporarily stores image data of a captured image(s) captured by the imaging unit 120.

The communication unit 350 is connected to other devices communicably through a wireless or wired communication network to transmit and receive various data. For example, the communication unit 350 is configured to include a wired LAN interface such as the Ethernet (registered trademark), a wireless LAN interface such as Wi-Fi (registered trademark), and the like.

The storage unit 360 is configured to include storage media, such as an HDD (Hard Disk Drive) or an SDD (Solid State Drive), a ROM, a flash ROM, and the like. The storage unit 360 stores the OS, device drivers, various programs such as applications, and various data acquired by the operation of the programs.

Note that the system processing unit 300 may be configured as one package of a SoC (System on a Chip), or some of the functions may be configured as any other part such as a chipset or a sensor hub.

### Configuration of Face Detection Unit

Next, the configuration of the face detection unit 220 will be described in detail.

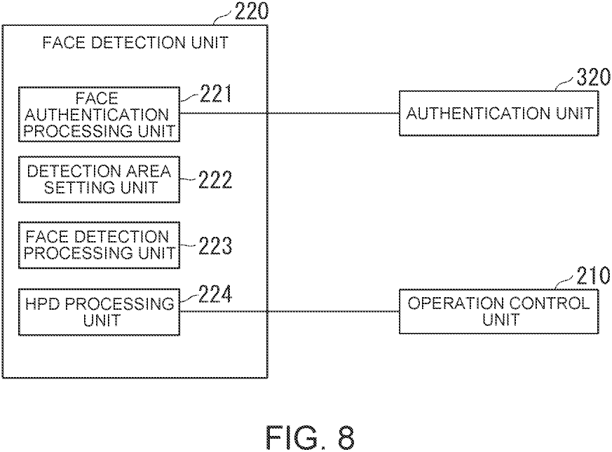

FIG. 8 is a block diagram illustrating the configuration of the face detection unit 220 according to one or more embodiments. The face detection unit 220 illustrated includes a face authentication processing unit 221, a detection area setting unit 222, a face detection processing unit 223, and an HPD processing unit 224.

The face authentication processing unit 221 detects a face area from a captured image in the high-accuracy detection mode to execute the face authentication processing. For example, in the high-accuracy detection mode, the face authentication processing unit 221 enables both the first camera 121 and the second camera 122, and causes the second camera 122 to emit infrared light. The face authentication processing unit 221 reads, from the system memory 310, image data of an RGB image and an IR image captured with the first camera 121 and the second camera 122, respectively. Then, the face authentication processing unit 221 detects a face area from the RGB image and the IR image to execute the face authentication processing.

Note that the face authentication processing unit 221 may also enable only the second camera 122 of the first camera 121 and the second camera 122 in the high-accuracy detection mode to detect a face area from the IR image in order to execute the face authentication processing.

For example, the face authentication processing unit 221 executes the face authentication processing upon a request from an authentication unit 320, and transmits the authentication result to the authentication unit 320 as a response to the request. The authentication unit 320 is a functional component implemented by the system processing unit 300 executing a program of the OS. Based on the authentication result by the face authentication processing unit 221, the authentication unit 320 performs authentication processing at login, authentication processing to access data the access of which is limited, and the like.

When the face area is detected by the face authentication processing unit 221 in the high-accuracy detection mode, the detection area setting unit 222 sets a high reliability area used to detect a face area in the standard detection mode based on the face area detected in the high-accuracy detection mode. Further, when the high reliability area is set in the standard detection mode, the detection area setting unit 222 updates the position of the high reliability area based on the position of the face area detected in the high reliability area. For example, when the position or size of the face area detected in the high reliability area changes, the detection area setting unit 222 changes the position or size of the high reliability area according to the change in the position or size of the face area. In other words, the detection area setting unit 222 causes the high reliability area to follow according to the change in the position or size of the face area (face movement) detected in the high reliability area.

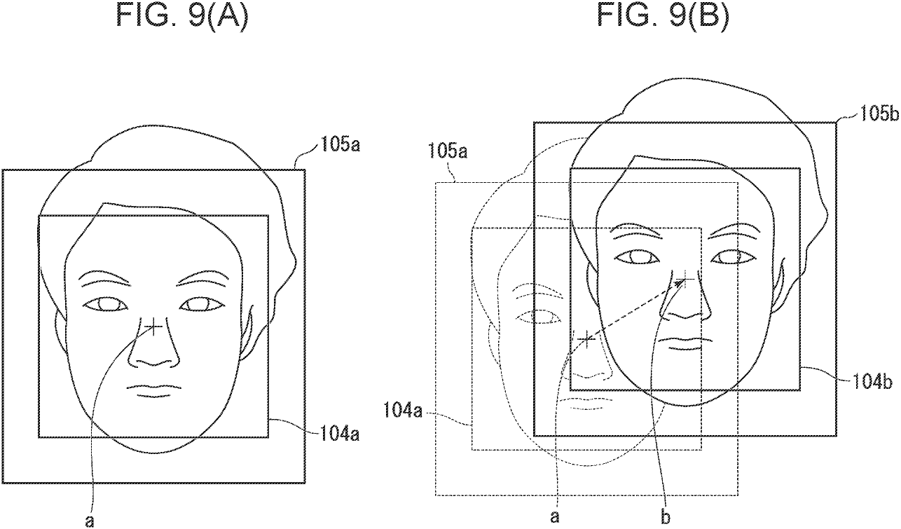

FIGS. 9(A) and 9(B) are explanatory diagram of tracking of the high reliability area according to one or more embodiments. FIG. 9(A) illustrates a bounding box 104a when a face area centered at position a is detected, and a high reliability area 105a set based on the bounding box 104a. As illustrated in FIG. 9(B), when the center of the face area is moved from position a to position b, the bounding box 104a and the high reliability area 105a move by following the movement of the face area, and become a bounding box 104b and a high reliability area 105b, respectively.

Note that when the face area is no longer detected in the high reliability area, the detection area setting unit 222 cancels the set high reliability area.

Returning to FIG. 8, the face detection processing unit 223 detects a face area from a captured image in the standard detection mode. For example, the face detection processing unit 223 enables only the first camera 121 of the first camera 121 and the second camera 122, and does not cause the second camera 122 to emit infrared light. The face detection processing unit 223 reads, from the system memory 310, image data of an RGB image captured with the first camera 121. Then, the face detection processing unit 223 detects a face area from the RGB image. For example, the face detection processing unit 223 detects an area, in which the face detection evaluation value is the face determination threshold value or more, from the RGB image as a face area.

Further, when the high reliability area is set upon detecting a face area from the captured image in the standard detection mode, the face detection processing unit 223 detects the face area with different detection conditions between the high reliability area and the standard area. Specifically, the face determination threshold value in the high reliability area is set lower than the face determination threshold value in the standard area. For example, the face determination threshold value in the high reliability area is set to a value lower by a predetermined percentage (for example, 10%) than the face determination threshold value in the standard area.

The HPD processing unit 224 determines whether or not the user is present in front of the electronic apparatus 1 based on whether or not a face area is detected from a captured image by the face detection processing unit 223. For example, when the face area is detected from the captured image by the face detection processing unit 223, the HPD processing unit 224 determines that the user is present in front of the electronic apparatus 1. On the other hand, when no face area is detected from the captured image by the face detection processing unit 223, the HPD processing unit 224 determines that the user is not present in front of the electronic apparatus 1. Then, the HPD processing unit 224 outputs HPD information based on the determination result of whether or not the user is present in front of the electronic apparatus 1.

For example, when the determination result is changed from a state in which the user is not present in front of the electronic apparatus 1 to a state in which the user is present, the HPD processing unit 224 outputs HPD information indicating that the user has approached the electronic apparatus 1 (hereinafter called “Approach information”). Further, while determining that the user is present in front of the electronic apparatus 1, the HPD processing unit 224 outputs HPD information indicating that the user is present in front of the electronic apparatus 1 (hereinafter called “Presence information”). Further, when the detected state is changed from the state in which the user is present in front of the electronic apparatus 1 to the state in which the user is not present, the HPD processing unit 224 outputs HPD information indicating that the user has left the electronic apparatus 1 (hereinafter called “Leave information”). Based on the detection result of the face area by the face detection processing unit 223, the HPD processing unit 224 outputs the Approach information, the Presence information, or the Leave information to an operation control unit 210.

The operation control unit 210 is a functional component implemented by the EC 200 executing a control program to acquire the HPD information output from the HPD processing unit 224 in order to control the system operating state based on the acquired HPD information.

For example, when acquiring the Approach information from the face detection unit 220 (the HPD processing unit 224) in the standby state, the operation control unit 210 makes the transition from the standby state to the normal operating state. Specifically, the operation control unit 210 gives an instruction to the system processing unit 300 to boot the system. More specifically, when booting the system, the operation control unit 21 outputs the control signal to the power supply unit 400 to supply power required for the operation of each unit of the electronic apparatus 1. After that, the operation control unit 210 outputs a boot signal to instruct the system processing unit 300 to boot the system. When acquiring the boot signal, the system processing unit 300 boots the system to make the transition from the standby state to the normal operating state.

Further, in the normal operating state, the operation control unit 210 continues the normal operating state while acquiring the Presence information from the face detection unit 220 (the HPD processing unit 224) to restrict the system not to make the transition to the standby state. Note that even when acquiring the Presence information from the face detection unit 220 (the HPD processing unit 224), the operation control unit 210 may also make the transition from the normal operating state to the standby state depending on given conditions. For example, the given conditions are that the period of time without no user operation input (no operation period of time) is continued for a preset period of time, that an operation to make the transition to the standby state is performed, and the like.

Further, when acquiring the Leave information from the face detection unit 220 (the HPD processing unit 224) in the normal operating state, the operation control unit 210 instructs the system processing unit 300 to cause the system to make the transition from the normal operating state to the standby state. More specifically, the operation control unit 210 outputs a standby signal to instruct the system processing unit 300 to cause the system to make the transition from the normal operating state to the standby state. When acquiring the standby signal, the system processing unit 300 causes the system to make the transition from the normal operating state to the standby state. After that, the operation control unit 210 outputs, to the power supply unit 400, a control signal to stop the supply of power unnecessary in the standby state.

### Operation of Face Detection Processing

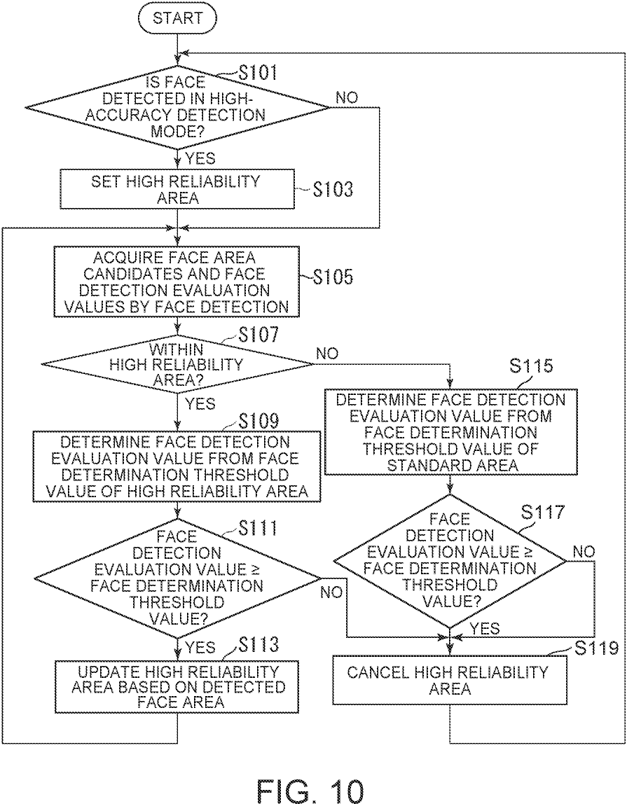

Referring next to FIG. 10, the operation of face detection processing in which the face detection unit 220 sets the high reliability area in the standard detection mode to detect a face area will be described.

FIG. 10 is a flowchart illustrating an example of face detection processing in the standard detection mode according to one or more embodiments.

(Step S101) The face detection unit 220 determines whether or not a face area is detected in the high-accuracy detection mode. For example, the face detection unit 220 determines whether or not a face area is detected in the high-accuracy detection mode in the face authentication processing at the last login time. The last login time is the login time upon booting for transition to the current normal operating state, which means a case where the normal operating state is continued after the login without the transition to the standby state or the stopped state after the login. When determining that a face area is detected in the high-accuracy detection mode (YES), the face detection unit 220 proceeds to a process in step S103. On the other hand, when determining that no face area is detected in the high-accuracy detection mode (NO), the face detection unit 220 proceeds to a process in step S105.

(Step S103) Based on the face area detected in the high-accuracy detection mode, the face detection unit 220 sets the high reliability area (see FIG. 4). Then, the face detection unit 220 proceeds to the process in step S105.

(Step S105) The face detection unit 220 performs face detection processing to detect a face area from a captured image in the standard detection mode. For example, the face detection unit 220 acquires face area candidates from the captured image and respective face detection evaluation values. Then, the face detection unit 220 proceeds to a process in step S107.

(Step S107) As for the most main face area candidate among the face area candidates detected from the captured image, the face detection unit 220 determines whether or not it is within the high reliability area. When determining that it is within the high reliability area (YES), the face detection unit 220 proceeds to a process in step S109. On the other hand, when determining that it is not within the high reliability area (i.e., when determining that it is within the standard area) (NO), the face detection unit 220 proceeds to a process in step S115.

(Step S109) The face detection unit 220 uses the face determination threshold value (for example, “63”) of the high reliability area to determine the face detection evaluation value of the face area candidate in the high reliability area. Then, the face detection unit 220 proceeds to a process in step S111.

(Step S111) The face detection unit 220 determines whether or not the face detection evaluation value is the face determination threshold value of the high reliability area or more. When determining that it is the face determination threshold value of the high reliability area or more (YES), the face detection unit 220 determines that it is the face area, and proceeds to a process in step S113. On the other hand, when determining that it is less than the face determination threshold value of the high reliability area (NO), the face detection unit 220 determines that it is not the face area, and proceeds to a process in step S119.

(Step S113) The face detection unit 220 updates the high reliability area based on the detected face area. For example, when the position or size of the detected face area is changed from the position or size of the last detected face area, the face detection unit 220 changes the position or size of the high reliability area according to the change in the position or size of the detected face area.

(Step S115) The face detection unit 220 uses the face determination threshold value (for example, “70”) of the standard area to determine the face detection evaluation value of any other face area candidate outside of the high reliability area (or in the state where the high reliability area is not set). Then, the face detection unit 220 proceeds to a process in step S117.

(Step S117) The face detection unit 220 determines whether or not the face detection evaluation value of the face area candidate is the face determination threshold value of the standard area or more. When determining that it is the face determination threshold value of the standard area or more (YES), the face detection unit 220 determines that it is the face area, and proceeds to the process in step S119. On the other hand, when determining that it is less than the face determination threshold value of the standard area (NO), the face detection unit 220 determines that it is not the face area, and proceeds to the process in step S119.

(Step S119) The face detection unit 220 cancels the high reliability area when the high reliability area is set. For example, in the state where the high reliability area is set, when no face area is detected in the high reliability area (step S111: NO), when a face area is detected in the standard area (step S117: YES), or when no face area is detected in both the high reliability area and the standard area (step S117: NO), the face detection unit 220 cancels the high reliability area. Note that when the high reliability area is not set (step S101: NO), the face detection unit 220 continues the state in which the high reliability area is not set. Then, the face detection unit 220 returns to the process in step S101.

As described above, the electronic apparatus 1 according to one or more embodiments includes the system memory 310 (an example of a memory) for temporarily storing image data of images (captured images) captured by the imaging unit 120 (an example of an imaging device), and the face detection unit 220 (an example of a processor) for processing image data stored in the system memory 310. The face detection unit 220 has the standard detection mode (an example of a first detection mode) in which a face area with a face captured therein is detected with a first detection accuracy (for example, the detection accuracy of face detection in HPD processing) from an image (captured image) of image data stored in the system memory 310, and the high-accuracy detection mode (an example of a second detection mode) in which the face area is detected with a second detection accuracy higher than the first detection accuracy (for example, the detection accuracy with which face authentication is performed). Then, when the face area is detected in the high-accuracy detection mode, the face detection unit 220 executes face detection processing in which the high reliability area (an example of a first area) based on the face area detected in the high-accuracy detection mode is set, and upon detecting the face area in the standard detection mode, the face area is detected with different detection conditions between the high reliability area and the standard area other than the high reliability area.

Thus, when detecting the face area in the standard detection mode, since the electronic apparatus 1 detects the face area with different detection conditions between the high reliability area based on the face area detected in the high-accuracy detection mode, in which the face area is detected with a detection accuracy higher than that in the standard detection mode, and the standard area other than the high reliability area, stable face detection can be performed while reducing the detection accuracy in the standard detection mode.

For example, in the face detection processing, the face detection unit 220 detects an area, in which the face detection evaluation value (an example of a face-likeness evaluation value) is the face determination threshold value (an example of a first threshold value) or more, as the face area from the captured image. Then, the face determination threshold value in the high reliability area is set lower than the face determination threshold value in the standard area.

Thus, since the electronic apparatus 1 makes it easier for only the high reliability area, in which the possibility that there is a face is high, to be detected as the face area, a person’s face area is more likely to be detected as the face area correctly without increasing the possibility that an area with no person’s face therein will be erroneously detected as the face area. Thus, the electronic apparatus 1 can realize stable face detection without increasing the detection accuracy in the standard detection mode.

Further, in the face detection processing, the face detection unit 220 changes the position or size of the high reliability area according to the change in the position or size of the face area detected in the standard detection mode.

Thus, even when the position of a user’s face is slightly moved during using the electronic apparatus 1, the electronic apparatus 1 can perform face detection stably.

For example, the imaging unit 120 includes the RGB sensor (an example of a first image sensor) for imaging visible light and the IR sensor (an example of a second image sensor) for imaging infrared light. The standard detection mode is a detection mode in which imaging is done using only the RGB sensor of the RGB sensor and the IR sensor, and the high-accuracy detection mode is a detection mode in which imaging is done using at least the IR sensor.

Thus, in the standard detection mode, the electronic apparatus 1 can detect a face area stably from a captured image captured by using the RGB sensor without using the IR sensor. Therefore, since there is no need to emit infrared light, the electronic apparatus 1 can realize stable face detection while reducing power consumption.

Further, the standard detection mode is a detection mode in which power consumed in the face detection processing is lower than that in the high-accuracy detection mode.

Thus, the electronic apparatus 1 can realize stable face detection while reducing power consumption.

Further, the standard detection mode is a detection mode for detecting a face area from a captured image. On the other hand, the high-accuracy detection mode is a detection mode for detecting a face area from a captured image to perform face authentication.

Thus, when detecting a face area, the electronic apparatus 1 can use a face area detected in face authentication processing with a high detection accuracy to perform stable face detection while reducing the detection accuracy.

In the standard detection mode, when any face area cannot be detected in the high reliability area, the face detection unit 220 cancels the high reliability area.

Thus, since erroneous detection of an area with no person’s face therein as a face area can be suppressed, the electronic apparatus 1 can perform stable face detection.

Further, a control method for the electronic apparatus 1, where the face detection unit 220 has the standard detection mode (the example of the first detection mode) in which a face area with a face captured therein is detected with the first detection accuracy (for example, the detection accuracy of face detection in HPD processing) from an image (captured image) of image data stored in the system memory 310, and the high-accuracy detection mode (the example of the second detection mode) in which the face area is detected with the second detection accuracy higher than the first detection accuracy (for example, the detection accuracy with which face authentication is performed), includes: a step in which, when the face area is detected in the high-accuracy detection mode, the high reliability area (the example of the first area) based on the face area detected in the high-accuracy detection mode is set; and a step in which, when the face area is detected in the standard detection mode, the face area is detected with different detection conditions between the high reliability area and the standard area other than the high reliability area.

Thus, when detecting the face area in the standard detection mode, since the face area is detected with different detection conditions between the high reliability area based on the face area detected in the high-accuracy detection mode, in which the face area is detected with a detection accuracy higher than that in the standard detection mode, and the standard area other than the high reliability area, the electronic apparatus 1 can perform stable face detection while reducing the detection accuracy in the standard detection mode.

### Second Embodiment

Next, a second embodiment of the present invention will be described.

In the first embodiment, when a face area is detected in the high-accuracy detection mode, since it can be determined that the reliability of the detection result is high (the possibility that there is a face is high), the high reliability area based on the detected face area is set to perform control to lower the face determination threshold value. In contrast, in one or more embodiments, when the face detection evaluation value is high even in the standard detection mode, since it can be determined that the reliability of the detection result is high (the possibility that there is a face is high), the high reliability area is set in the same way to perform control to lower the face determination threshold value.

For example, when a face area in which the face detection evaluation value becomes a threshold value higher than a face determination threshold value (hereinafter called a “high-reliability determination threshold value”) or more is detected by the face detection processing unit 223, the detection area setting unit 222 sets a high reliability area based on the detected face area. Then, upon detecting the face area after that, the face detection processing unit 223 performs face detection processing to detect the face area with different detection conditions between the high reliability area and the standard area. Specifically, like in the first embodiment, the face determination threshold value in the high reliability area is set to a value lower by a predetermined percentage (for example, 10%) than the face determination threshold value in the standard area.

For example, when the high reliability area is canceled in the standard detection mode due to the fact that the face area cannot be detected in the high reliability area, the detection area setting unit 222 uses this high-reliability determination threshold value to determine a face detection evaluation value in order to set the high reliability area. After the high reliability area is canceled, when a face area in which the face detection evaluation value becomes a high-reliability determination threshold value or more is detected in the standard detection mode, the detection area setting unit 222 sets the high reliability area based on the detected face area again.

Similarly, for example, even when any high reliability area is not originally set in the standard detection mode, the detection area setting unit 222 may also use this high-reliability determination threshold value to determine a face detection evaluation value in order to set the high reliability area.

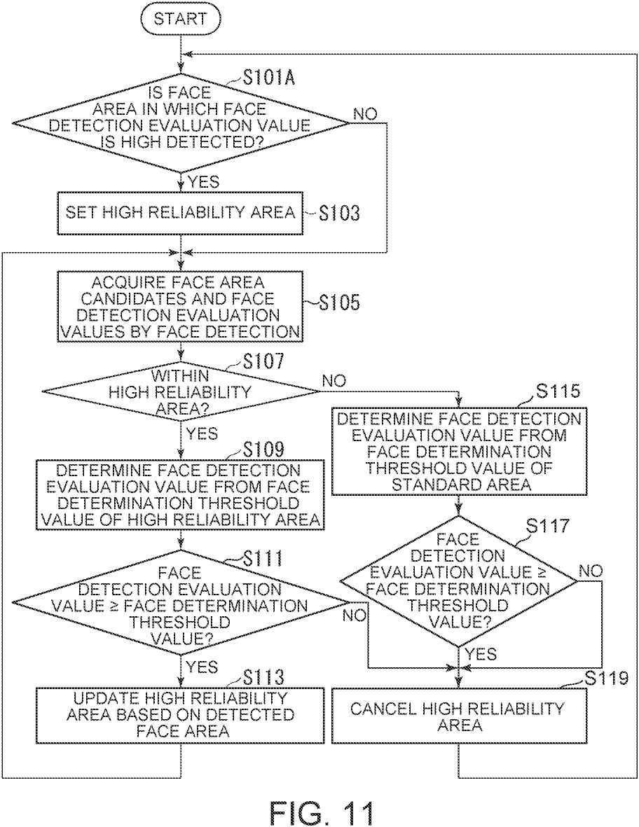

FIG. 11 is a flowchart illustrating an example of face detection processing in the standard detection mode according to one or more embodiments. In FIG. 11, the same step numbers are given to steps corresponding to respective processes illustrated in FIG. 10 to omit the description thereof. In one or more embodiments, only a process in step S101A as a trigger to set a high reliability area is different from the process in step S101 illustrated in FIG. 10.

(Step S101A) In the standard detection mode, the face detection unit 220 determines whether or not a face area in which the face detection evaluation value is high is detected. For example, in the standard detection mode, the face detection unit 220 determines whether or not a face area in which the face detection evaluation value becomes the high-reliability determination threshold value or more is detected. When determining that a face area in which the face detection evaluation value is the high-reliability determination threshold value or more is detected (YES), the face detection unit 220 sets a high reliability area (step S103), and performs face detection processing (step S105). On the other hand, when determining that any face area in which the face detection evaluation value is the high-reliability determination threshold value or more is not detected (NO), the face detection unit 220 performs face detection processing without setting the high reliability area (step S105). Subsequent processing is the same as the processing illustrated in FIG. 10.

As described above, the electronic apparatus 1 according to one or more embodiments includes the system memory 310 (the example of the memory) for temporarily storing image data of images (captured images) captured by the imaging unit 120 (the example of the imaging device), and the face detection unit 220 (the example of the processor) for processing image data stored in the system memory 310. The face detection unit 220 executes face detection processing to detect an area, in which the face detection evaluation value (the example of the face-likeness evaluation value) is the face determination threshold value (the example of the first threshold value) or more, from an image (captured image) of image data stored in the system memory 310 as a face area. Then, in the face detection processing, when a face area in which the face detection evaluation value becomes a high-reliability determination threshold value (an example of a second threshold value) or more is detected, where the high-reliability determination threshold value is higher than the face determination threshold value, the face detection unit 220 sets the high reliability area (the example of the first area) based on the detected face area, and upon detecting the face area after that, the face detection unit 220 detects the face area with different detection conditions between the high reliability area and the standard area other than the high reliability area.

Thus, when detecting the face area from the captured image, since the electronic apparatus 1 detects the face area with different detection conditions between the high reliability area, in which the possibility that there is a face is high, and the standard area other than the high reliability area (for example, from different face determination threshold values), the electronic apparatus 1 can perform stable face detection while reducing the detection accuracy.

For example, in the standard detection mode (the example of the first detection mode), when any face area cannot be detected in the high reliability area, the face detection unit 220 cancels the high reliability area. After canceling the high reliability area, when a face area in which the face detection evaluation value becomes the high-reliability determination threshold value or more is detected in the standard detection mode, the face detection unit 220 sets the high reliability area based on the detected face area again.

Thus, even when the high reliability area based on the face area is detected in the high-accuracy detection mode, in which the face area is detected with a detection accuracy higher than that in the standard detection mode, is not set upon detecting the face area in the standard detection mode, the electronic apparatus 1 can set an area in which the possibility that there is a face is high as the high reliability area to increase the possibility that a person’s face area will be detected as the face area correctly.

Further, a control method for the electronic apparatus 1 includes: a step of causing the face detection unit 220 to detect an area, in which a face detection evaluation value (the example of the face-likeness evaluation value) is a face determination threshold value (the example of the first threshold value) or more, from an image (captured image) of image data stored in the system memory 310 as a face area; a step in which, when a face area in which the evaluation value becomes a high-reliability determination threshold value (the example of the second threshold value) or more is detected, where the high-reliability determination threshold value is higher than the face determination threshold value, the face detection unit 220 sets a high reliability area (the example of the first area) based on the detected face area; and a step in which, upon detecting the face area after that, the face detection unit 220 detects the face area with different detection conditions between the high reliability area and a standard area other than the high reliability area.

Thus, when detecting the face area from the captured image, since the electronic apparatus 1 detects, from the captured image, the face area with different detection conditions between the high reliability area, in which the possibility that there is a face is high, and the standard area other than the high reliability area (for example, from different face determination threshold values), the electronic apparatus 1 can perform stable face detection while reducing the detection accuracy.

While the respective embodiments of this invention have been described in detail above with reference to the accompanying drawings, the specific configurations are not limited to the above-described embodiments, and design changes are included without departing from the scope of this invention. For example, the respective processing configurations described above in the respective embodiments can be combined arbitrarily.

Further, in the aforementioned embodiments, the configuration example in which the imaging unit 120 is built in the electronic apparatus 1 is described, but the present invention is not limited to this example. For example, the imaging unit 120 does not have to be built in the electronic apparatus 1, which may also be attachable to the electronic apparatus 1 (for example, onto any of the side faces 10a, 10b, 10c, and the like) and communicably connected to the electronic apparatus 1 wirelessly or by wire as an external accessory.

Further, in the aforementioned embodiments, the electronic apparatus 1 detects a face area with a face captured therein from a captured image(s) to detect the presence of the user, but an area to be detected is not limited to the face area with a face captured therein, and the presence of the user may also be detected by detecting an area in which at least part of the body is captured. Further, the electronic apparatus 1 may use a distance sensor (for example, a proximity sensor or the like) together to detect the distance to an object. For example, the distance sensor is provided on the inner face side of the first chassis 10 to detect an object (for example, a person) present within a detection range in a direction (forward) to face the inner face of the first chassis 10. As an example, the distance sensor may be an infrared distance sensor configured to include a light-emitting part for emitting infrared light and a light-receiving part for receiving reflected light which is the infrared light returned after being emitted and reflected on the surface of the object. Note that the distance sensor may be a sensor using infrared light emitted by a light-emitting diode, or a sensor using an infrared laser emitting a light beam narrower in wavelength band than the infrared light emitted by the light-emitting diode. Further, the distance sensor is not limited to the infrared distance sensor, and it may be a sensor using any other method, such as an ultrasonic sensor or a sensor using a UWB (Ultra Wide Band) radar, as long as the sensor detects the distance to the object. Further, the distance sensor does not have to be built in the electronic apparatus 1, which may also be attachable to the electronic apparatus 1 (for example, onto any of the side faces 10a, 10b, 10c, and the like) and communicably connected to the electronic apparatus 1 wirelessly or by wire as an external accessory. Further, the imaging unit 120 and the distance sensor may be integrally constructed. For example, the integrated construction of the imaging unit 120 and the distance sensor may also be used for face authentication processing.

Further, in the aforementioned embodiments, the example in which the face detection unit 220 is provided separately from the EC 200 is illustrated, but some or all of the functions of the face detection unit 220 may be provided in the EC 200, or some or all of the functions of the face detection unit 220 and the EC 200 may be configured as one package. Further, some or all of the functions of the face detection unit 220 may be provided in the system processing unit 300, or some or all of the functions of the face detection unit 220 and some or all of the functions of the system processing unit 300 may be configured as one package. Further, some or all of the functions of the operation control unit 210 may be implemented as a functional component of any processing unit other than the EC 200 (for example, of the system processing unit 300).

Note that the electronic apparatus 1 described above has a computer system therein. Then, a program for implementing the function of each component included in the electronic apparatus 1 described above may be recorded on a computer-readable recording medium so that the program recorded on this recording medium is read into the computer system and executed to perform processing in each component included in the electronic apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a portable medium like a flash ROM or a CD-ROM, or a hard disk incorporated in the computer system. The recording medium with the program stored thereon may be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the electronic apparatus 1, or delivery servers for delivering respective divided pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called differential file (differential program) capable of implementing the above-described functions in combination with a program(s) already recorded in the computer system.

Further, some or all of the functions of the electronic apparatus 1 in the above-described embodiments may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Note that the electronic apparatus 1 is not limited to the laptop PC, and it may also be a desktop PC, a tablet terminal device, or a smartphone. Further, the electronic apparatus 1 is not limited to the PC, the tablet terminal device, the smartphone, or the like, and the present invention can also be applied to a household electric appliance or a commercial electric appliance. As the household electric appliance, the present invention can be applied to a TV set, a refrigerator or a microwave oven having a display unit, or the like. For example, ON/OFF of a TV screen or ON/OFF of a screen of the display unit of the refrigerator or the microwave oven can be controlled in response to the approach or leave of a person. As the commercial electric appliance, the present invention can be applied to a vending machine, a multimedia station, or the like. For example, an operating state such as ON/OFF of lighting of the vending machine or ON/OFF of a screen of a display unit of the multimedia station can be controlled in response to the approach or leave of a person.

### DESCRIPTION OF SYMBOLS

1 electronic apparatus
10 first chassis
20 second chassis
15 hinge mechanism
110 display unit
120 imaging unit
121 first camera
122 second camera
130 acceleration sensor
140 power button
150 input device
151 keyboard
153 touch pad
160 video output terminal
200 EC
210 operation control unit
220 face detection unit
221 face authentication processing unit
222 detection area setting unit
223 face detection processing unit
224 HPD processing unit
300 system processing unit
302 CPU
304 GPU
306 memory controller
308 I/O controller
310 system memory
320 authentication unit
350 communication unit
360 storage unit
400 power supply unit

What is claimed is:

1. An electronic apparatus comprising:
a memory which temporarily stores image data of an image captured by an imaging device; and
a processor which processes image data stored in the memory, wherein
the processor has a first detection mode in which a face area with a face captured therein is detected with a first detection accuracy from the image of image data stored in the memory, and a second detection mode in which the face area is detected with a second detection accuracy higher than the first detection accuracy, and
when the face area is detected in the second detection mode, the processor executes face detection processing in which a first area based on the face area detected in the second detection mode is set, and upon detecting the face area in the first detection mode, the face area is detected with different detection conditions between the first area and a second area other than the first area.

2. The electronic apparatus according to claim 1, wherein
in the face detection processing, the processor detects an area, in which a face-likeness evaluation value is a first threshold value or more, as the face area from the image, and
the first threshold value in the first area is set lower than the first threshold value in the second area.

3. The electronic apparatus according to claim 1, wherein in the face detection processing, the processor changes position or size of the first area according to a change in position or size of the face area detected in the first detection mode.

4. The electronic apparatus according to claim 1, wherein
the imaging device includes a first image sensor for imaging visible light and a second image sensor for imaging infrared light, and
the first detection mode is a detection mode in which imaging is done using only the first image sensor of the first image sensor and the second image sensor, and the second detection mode is a detection mode in which imaging is done using at least the second image sensor.

5. The electronic apparatus according to claim 1, wherein the first detection mode is a detection mode in which power consumed in the face detection processing is lower than that in the second detection mode.

6. The electronic apparatus according to claim 1, wherein
the first detection mode is a detection mode for detecting the face area from the image, and
the second detection mode is a detection mode for detecting the face area to perform face authentication from the image.

7. The electronic apparatus according to claim 1, wherein when the face area cannot be detected in the first area in the first detection mode, the processor cancels the first area.

8. The electronic apparatus according to claim 2, wherein
when the face area cannot be detected in the first area in the first detection mode, the processor cancels the first area, and
after canceling the first area, when the face area in which the evaluation value becomes a second threshold value or more is detected in the first detection mode, where the second threshold value is higher than the first threshold value, the processor sets the first area based on the detected face area again.

9. An electronic apparatus comprising:
a memory which temporarily stores image data of an image captured by an imaging device; and
a processor which processes image data stored in the memory, wherein
the processor executes face detection processing to detect an area, in which a face-likeness evaluation value is a first threshold value or more, as a face area from the image of image data stored in the memory, and
in the face detection processing, when the face area in which the evaluation value becomes a second threshold value or more is detected, where the second threshold value is higher than the first threshold value, the processor sets a first area based on the detected face area to detect the face area with different detection conditions between the first area and a second area other than the first area upon detecting the face area after that.

10. A control method for an electronic apparatus including a memory which temporarily stores image data of an image captured by an imaging device, and a processor which processes image data stored in the memory, wherein the processor has a first detection mode in which a face area with a face captured therein is detected with a first detection accuracy from the image of image data stored in the memory, and a second detection mode in which the face area is detected with a second detection accuracy higher than the first detection accuracy, the control method comprising:
a step in which, when the face area is detected in the second detection mode, a first area based on the face area detected in the second detection mode is set; and
a step in which, upon detecting the face area in the first detection mode, the face area is detected with different detection conditions between the first area and a second area other than the first area.

11. A control method for an electronic apparatus including a memory which temporarily stores image data of an image captured by an imaging device, and a processor which processes image data stored in the memory, the control method comprising:
a step of causing the processor to detect an area, in which a face-likeness evaluation value is a first threshold value or more, as a face area from the image of image data stored in the memory;
a step in which, when the face area in which the evaluation value becomes a second threshold value or more is detected, where the second threshold value is higher than the first threshold value, the processor sets a first area based on the detected face area; and
a step in which, upon detecting the face area after that, the processor detects the face area with different detection conditions between the first area and a second area other than the first area.
